(19) United States
(12) Patent Application Publication
(10) Pub. No.: US 2022/0156787 A1
(43) Pub. Date: May 19, 2022

(54) Video Production Platform

(71) Applicant: Fancy Pants Online Inc., New York, NY (US)

(72) Inventor: Raymond Koo, New York, NY (US)

(21) Appl. No.: 17/455,567

(22) Filed: Nov. 18, 2021

Related U.S. Application Data
(60) Provisional application No. 63/115,791, filed on Nov. 19, 2020.

(51) Int. Cl. G06Q 30/02; H04N 21/81; H04N 21/431; H04N 21/258

(52) U.S. Cl. CPC G06Q 30/0246; H04N 21/812; H04N 21/25883; H04N 21/4312; G06Q 30/0244

(57) ABSTRACT

A system for video generation having a computer, a database in data communication with the computer, a plurality of blueprints and a user device in data communication with the computer. The computer receives at least one asset and a selection of a blueprint from the user device. The computer generates a video based on the at least one asset and the blueprint associated with the selection. The computer is in data communication with at least one advertising platform which receives the video and displays the video. The advertising platform generates performance data based on the display of the video. The computer generates a second video based on the at least one asset, the blueprint associated with the selection, and the performance data.

### CROSS-REFERENCE TO RELATED APPLICATIONS

This disclosure claims the benefit, under 35 U.S.C. § 119(e), of U.S. Provisional Patent Application No. 63/115,791, filed Nov. 19, 2020, the contents of which are incorporated herein by reference in their entirety.

### TECHNICAL FIELD

The present invention relates to the field of video advertising. Specifically, the present invention relates to scalable creation and performance optimization of social video advertisements.

### BACKGROUND

All consumer behaviors are driven by underlying personality traits. The highly rational shopper obsesses over facts and details, and must assess a purchase from several angles before making a decision. Another type of buyer may be drawn to the theoretical, abstract, and symbolic messages in an ad. Yet another customer type is captivated only by intrigue.

In the world of direct-to-consumer (DTC) social and mobile advertising, in order to be successful, brands need a variety of video advertisements that speaks to the diverse personalities of their audience. There are numerous video advertisement solutions in the current market, offering speed, low cost, and scalability, however, the market lacks a solution for effective personalized video ads at scale.

In addition, video rendering is computer resource-intensive and time-consuming. When video rendering is part of a software as a service (SaaS) offering that allows high-volume users to demand video rendering concurrently, the performance issue becomes much more apparent. Therefore, a web browser-based video editing platform where editing is done on cloud-powered distributed systems is desired.

Finally, consumers interact with a variety of electronic devices on a daily basis, including smartphones, televisions, desktop and laptop computers, and tablets. Various aspect ratios and typesetting issues arise when generating videos for multiple platforms.

### SUMMARY

An objective of the present invention is to provide a way to communicate a product's value effectively to different groups of people.

An objective of the present invention is to provide a system which supports effective continuous improvement of video advertisements towards a goal of converting online shoppers.

An objective of the present invention is to provide a video creation system which can be used by web browsers and provides a user-friendly interface, making the process quick and easy.

An objective of the present invention is to provide a video creation system which makes it easy to create, customize, and export videos.

An objective of the present invention is to provide a video creation system where rendering is done on the cloud powered by distributed file systems and server clusters.

An objective of the present invention is to provide a video creation system which can scale when handling thousands, if not millions, of video rendering requests.

An objective of the present invention is to provide a video creation system with a variety of adaptive video layouts and text typesetting solutions to meet the challenges of multiple aspect ratio specifications.

An objective of the present invention is to provide a video creation system which provides a scheme for rendering videos based on feed data for large batch of multi-version video rendering.

An objective of the present invention is to provide a video creation system which includes asynchronous communication between servers via message queues, to avoid excessive load or failure of different types of servers from affecting the processing of users' video generation requests.

An objective of the present invention is to provide a video creation system which includes cache-and-prevent-re-rendering scheme to fix how to prevent the same scene from being rendered multiple times when similar videos are rendered multiple times.

An objective of the present invention is to provide a video creation system which includes an agent designed to monitor server health and work load and automatically scale server instances.

An objective of the present invention is to provide a video creation system which includes a solution for the layout of an adaptive situation and the layout of text animation.

An objective of the present invention is to provide a video creation system which includes a plan to produce videos in batches according to the definition of feed, which essentially realizes the automatic mapping relationship from data to video.

An objective of the present invention is to enable creation of numerous short-form videos that advertise a given product using a broad set of video techniques designed to resonate with a broad spectrum of shopper personality types. These video advertisements are then served in market and monitored to measure user engagement and monitor ad performance. Sequential advertising units can customized and continually be served based on observed results until conversion goals are achieved.

In one aspect of the disclosure, a system for video generation is provided having a computer, a database in data communication with said computer, a plurality of blueprints and a user device in data communication with said computer. The computer receives at least one asset and a selection of a blueprint from said user device. The computer generates a video based on the at least one asset and the blueprint associated with said selection. The computer is in data communication with at least one advertising platform which receives the video and displays the video. The advertising platform generates performance data based on the display of the video. The computer generates a second video based on the at least one asset, the blueprint associated with said selection, and the performance data.

### BRIEF DESCRIPTION OF THE DRAWINGS

FIG. 1 shows a schematic diagram of a video production platform.

FIG. 2 shows a schematic diagram of a video production platform.

FIG. 3 shows a flowchart for a video production platform.

FIG. 4 shows a schematic diagram for a video production platform.

FIG. 5 shows a blueprint for use in a video production platform.

FIG. 6 shows a blueprint for use in a video production platform.

FIG. 7 shows an example of table-based data for use in feed-based mass video generation.

FIG. 8 shows an example of structured data for use in feed-based mass video generation.

### DETAILED DESCRIPTION

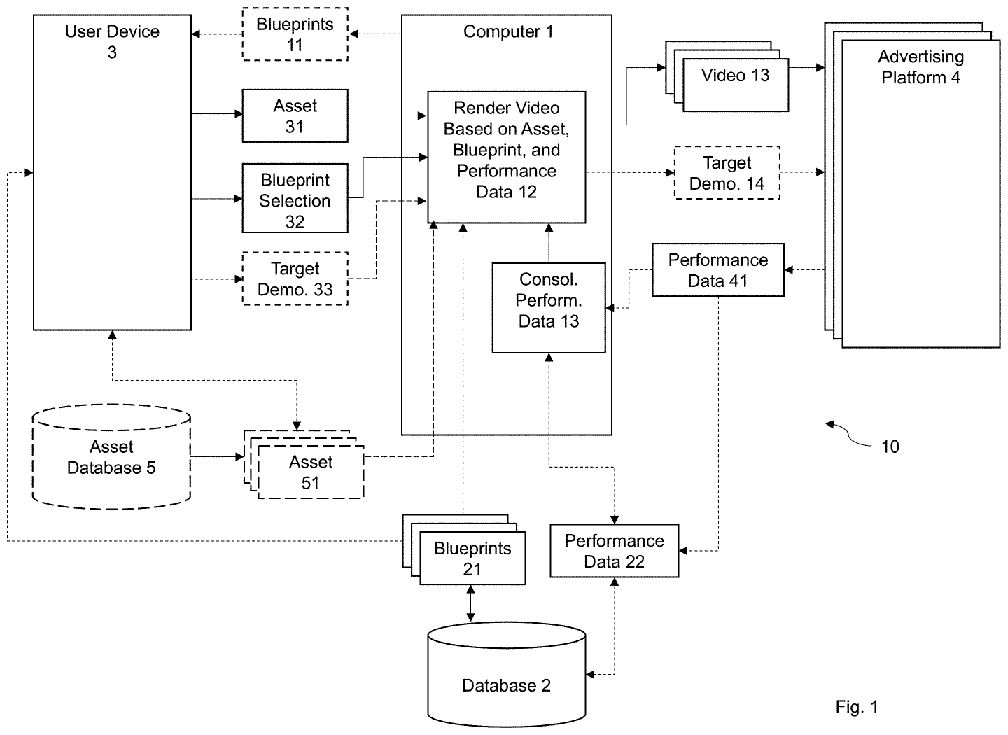

Regarding, FIG. 1, a video generation system 10 is disclosed.

The video generation platform may include a computer 1. The computer 1 may be a processor, remote computer, computer server, network, combinations thereof, or any other computing resource.

The computer 1 may be in communication with a database 2. The database 2 may store and retrieve information regarding the system 10, including blueprints 21 and performance data 22. When storing information, the database may include additional meta-information. For example, it may store the identity of the user from which the data came, a date and time stamp, or any other meta-information that may be useful to the system 10.

Blueprints 21 may be the initial template used to create a video. A blueprint 21 may contain a configuration file that contains input parameter settings for the user to set through the interface when creating the video. The blueprint 21 may also contain the initial resource files, file relationships, adaptive size-related logical settings; it may also include some script files used to modify related files after the user has replaced resources or set parameters.

Performance data 22 may include historical information regarding video advertisements run using videos generated by the system 10. The performance data 22 may include demographic, engagement, and/or conversion information, or any other information helpful to determine whether a video advertisement is having its desired effect. The performance data 22 may be anonymized or consolidated. The performance data 22 may be grouped, for example by target demographic, content type, or other known category.

The computer 1 may be in communication with a user device 3. The user device 3 may be a computer, laptop, smartphone, tablet, or other electronic device, including mobile devices, capable of transmitting data to the computer 1. The user device 3 may also include cloud databases accessible to such an electronic device, such as Dropbox or OneDrive. The user device 3 may run an application on a mobile device or smartphone. The user device 3 may run a web browser.

The user device 3 may be used to instruct the computer 1 to generate new videos 13. The user device 3 may receive a list of available blueprints 11. The user device 3 may provide a blueprint selection to the computer 1. The user device 3 may also provide at least one asset 31 to the computer 1. The asset 31 may be an image, video, 3D objects, copy text, audio, or any other type of media that will be included in the generated video 13. The asset(s) 31 may be associated with a brand, such as a logo, typeface, slogan, copy, etc.

Alternatively or in addition, the computer 1 or the user device 3 may be in data communication with an asset database 5. The computer 1 or the user device 3 may select and use an asset 51 from the asset database 5 for inclusion in the video 13. The asset database 5 may be a third-party database.

The computer 1 may also receive a target demographic 33 from the user device 3. The target demographic 33 may specify the type of person to be targeted by the advertisement, either by age, sex, gender, shopper type, etc.

The computer 1 may use the blueprint selection 32 to retrieve a blueprint 21. The blueprint 21 and any assets 31/51 may be used to generate 12 a video 13. The computer 1 may also use any performance data 12 in generating the video 13 by tweaking the blueprint 21.

Multiple videos 13 may be generated. The multiple videos 13 may target different demographics, or sell different products under the same brand. Using the same blueprint 21 can lead to increased brand identity between advertisements.

The computer 1 may be in communication with an advertising platform 4. The advertising platform 4 may be any platform that allows video advertisements, such as social media, television, or other video network.

The video 13 is provided to the advertising platform 4. Target demographics 14 may also be provided to the advertising platform 4 to ensure the video 13 is shown according to the intended audience. The advertising platform 4 provides performance data 41 to the computer. The performance data 21 may be consolidated 13 to assist in the generation of additional videos.

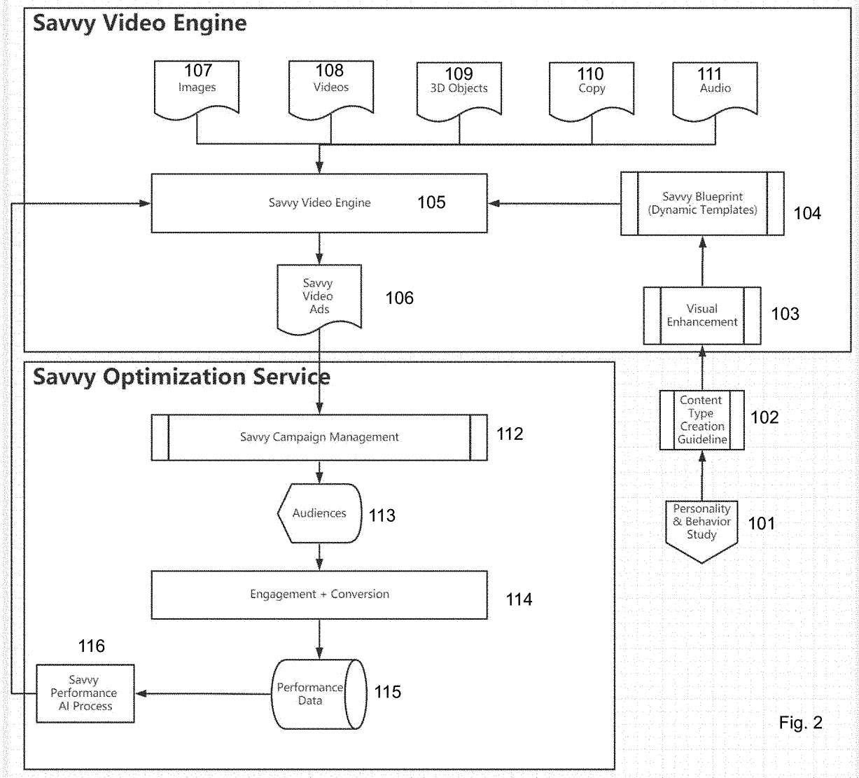

Regarding to FIG. 2, the video generation platform may begin with a personality study and content guidelines.

The system can begin in step 101 by analyzing the personality spectrum and categories the create specific shopper types, by personality. In steps 102 and 103, the system can design video advertising communication techniques to different groups of shopper personalities. Short video clips, consisting of text, imagery, video, and sound, all designed convey information in ways that fit the different shopper personalities, can be created in step 103. The related personality data for each clip can be stored in metadata.

The video engine 105 is a software-empowered process whereby resulting library of video templates from the personality study are integrated into our dynamic video system, each template being composed of multiple clips; each clip designed for one or more personality types. Video ad templates 104 are then selected, populated with a brand's assets (including but not limited to imagery 107, video 108, text 110, fonts, and 3D objects 109, and audio 111) and the video engine 105 outputs several video ad variants 106, covering a broad spectrum of shopper personality types, and tailored to a brand's aesthetic based on the assets provided.

Campaign management software 112 can be used to improve the advertisements. Information regarding a customer's target audience 113 (Facebook/Instagram), which contains information including occupations, interests, activities, etc. may be collected, along with information 114 regarding engagement and conversion, and consolidated into performance data 115. Software 116, modeled after key personality theories including Holland's Typology, the Myers-Briggs Type Indicator (MBTI), and the Big Five marker scales (OCEAN)—helps break down audience data to reveal the underlying factors for advertisement effectiveness. This enables the system to form connections in personality traits from various types of analytical theories to improve the effectiveness of ads.

As one example, an intuitive thinker focuses on the bigger picture and makes decisions using logical criteria. To better appeal to this personality type, we leverage content portraying factual claims and product features and benefits. If we present this person with an ad that instead carries emotional appeal, such as showcasing a product experience, it's less likely to resonate with them. However, if they are presented with product comparison ads or ads featuring expert reviews, there is a much higher chance it will engage them and lead to conversion.

The optimization conducts rapid test-and-learn cycles using the video variants generated from our video engine, leveraging performance and personality analytics to expose and improve winning ads and hone the effectiveness of the advertising campaign.

This is accomplished by first placing the video ads in market (Facebook/Instagram), set up as either A/B or Multivariate tests. Each ad's audience engagement data (including but not limited to ad views, ad clicks, landing page clicks, add to cart count, abandon cart count, return to cart count) is then tracked and based on these findings, audiences are continuously filtered and re-segmented into more refined groups, informing future retargeting. Additionally, the blueprints 104 enable quick adjustment to layout, copy and motion, and changes to these elements are aimed at enhancing the visual appeal of the video ad creative. With each repeated iteration, each videos' potential for resonance with the target audience is improved.

The system maintains an awareness of the full-funnel experience and customer path to conversion (funnel) and serves advertisements depending on which stage of the purchase funnel the audience is currently in. It is capable of retargeting with cross-sell promotions as well as serving sequential advertisements featuring product features, benefits, and experiences.

The system may be considered as a nested matrix:

The first matrix is the template matrix, where the X variable is layout, the Y is messaging, and the Z is motion.

The second matrix is the story matrix, where X is template matrix, the Y is personality and the Z is iteration (test-and-learn).

The third matrix is the improved matrix, where the X is the story matrix, the Y is the funnels, and the Z is behavior.

Therefore, the system helps manage the entire video advertisement system based on the product(s), time, location (social platform placement), and audiences, powered by analytics. The system generates as many videos as are needed to reach success.

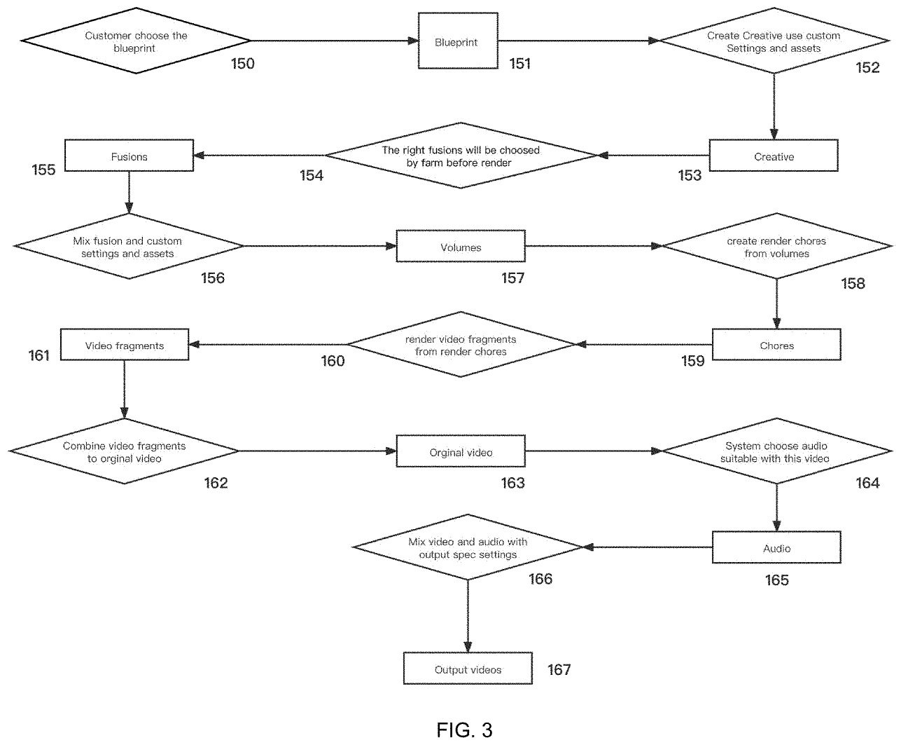

A sample flowchart for the video generation system is shown in FIG. 3.

The customer may choose a blueprint 151 in step 150. The blueprint 151 is an initial template used to create a video. A blueprint may contain a configuration file that contains the input parameter settings for the user to set through the interface when creating the video. The blueprint 151 may also contain the initial resource files, file relationships, adaptive size-related logical settings. The blueprint 151 may also include some script files used to modify related files after the user has replaced resources or set parameters.

The blueprint 151 may be used to create a “creative” 153 in step 152. The creative 153 is a blueprint file, along with its associated resource files and input and output settings. A creative 153 can create multiple videos of different specifications according to the user's settings to adapt to different platforms.

Fusions 155 are then selected in step 154. Fusions are plugins that can render the video resource files. Before rendering, the system will decide which fusion 155 to use for the final output according to creative's 153 output setting. There may be a mutual dependency relationship between fusions 155 as well, meaning that the video output by one fusion 155 may be used as input to another fusion 155. Example fusions included in the blueprint may be AE, NUKE, Houdini, and UE.

A blueprint 151 may define multiple fusions 155. For example, different output aspect ratios use different fusions 155 to break up the video into different segments, each segment being a separate fusion 155. It may be a no-fields input fusion 155 vs. a field input fusion 155 depending on the needs of each blueprint 151. Fusions 155 may be rendered in different rendering software, and there may be referencing between fusions 155.

The fusion 155 then are mixed 156 with custom settings and assets to create volumes 157. Before the rendering server renders, the server will synthesize the fusion 155 and other files for the video, according to parameters inputted by the user and the blueprint 151. It can be viewed as volume 157 after merging user input.

Volume 157 can be altered via hook, which is essentially a script function that can be run in fusions 155 such as AE, Nuke, and other synthesis software. In each stage of video rendering, a specific hook will be called, and volume 157 can be altered via hooks. Internal element layouts, animation patterns, etc. can be changed and tweaked too to increase the flexibility of the video creation process in the blueprint 151.

Chores 159 are created 158 from the volumes 157. Chores 159 are requests to produce a video, split into fragments. These chores 159 will have different types of rendering tasks and will be executed in a specific order.

The video fragments 161 are then rendered 160 from chores 159. A video fragment 161 is a collection of video segments in sequence. The video rendering task is broken down into many small steps, and these steps will produce a video which includes a specific frame-interval. Video fragments 161 are split into smaller chunks, and they can be sent to different farm node servers. Video fragments 161 can be rendered simultaneously to increase rendering speed. The probability that different creatives 153 render the same video fragments 161 may be far greater than the likelihood that one single creative 153 renders the same complete video 167. By caching video fragments, creatives 153 with different settings can avoid repeated rendering of the same video fragments 161, which can greatly improve rendering efficiency and reduce server resource consumption.

The video fragments 161 are then combined 162 into an initial video 163. Audio 165 is selected 164 for the video and mixed 166 therewith. The actual rendered video output 167, generated in a specific encoding and specification.

As discussed above, the rendering and caching portions of the video generation system lead to increased performance and ultimately better customized advertisements.

At the start, the rendering initialization task is generated According to the user's input data combined with the selected blueprint 151. When the rendering initialization task is executed, the dependencies between volumes 157 are mapped out, and the volume-related creation and rendering tasks are generated according to the dependencies. Volumes 157 need to be started after all the rendering tasks of the others relying on them have been completed. A volume's 157 rendering task is divided into multiple chores 159 to render small video clips. According to the user's output settings, the volume 157 is synthesized to produce the final video output 167 of the video clip 167.

Video rendering itself consumes a ton of system resources, so the same video 167 should not be rendered multiple times, which would use up server resources and cause slow render speeds. While there are not many identical videos that can be generated, often just a certain part or some fragments 161 are the same. Therefore, the rendering cache uses a variety of caching strategies to maximize rendered results. For two blueprints 151, if the input field values are identical, then the original video output should also be identical. After that, the original video is configured according to different output parameters, and exported to satisfy the requirements of the final output video 167.

For the exact same input fields, the created volume 157 should be the same. By calculating the has value of a blueprint identifier, version number and all input field values, the system can check if the relevant hash value exists, and if it does, reuse the existing volume 157, sparing the need to reprocess.

According to the video frame range information affected by each input field, the whole video rendering task is reasonably divided into many smaller chores 159. Only a few frames of video are rendered, and the rendering results are reused on a large scale. For example: frame1 affects 1-25 frames of video, and frame2 affects 26-40 frames of video. Then, 1-25 frames are used as a rendering task, and 26-40 frames are used as a separate rendering task. Multiple videos are only different in the beginning or end, and the difference between the beginning and the end is caused by the input.

Every input field defined in blueprint 151 can affect the video interval. When creating the rendering chores 159, the definition of this interval will be considered, and different parts will be placed in chores 159, but the same part will be placed in another chore 159. Each time the same part of chore 159 is shared, but different chores 159 are rendered and merged with the same part of chores 159 to produce the video.

Optimizations during production of a blueprint 151 are possible. For example, the main part of the video may stay the same, but the introductory text as described above does not change. Therefore, the video only needs to be rendered once for the background in a fusion 155. The different text overlays are placed in a fusion 155 called “cover”, and there is a total fusion 155 called “mix”. The mix takes background and cover as inputs. When it comes to rendering, the background only needs to be rendered once.

The audio 165 can also be synthesized with cached videos that were rendered in the very early stages.

Occasionally, it may occur that multiple video generation requests are sent at the same time to render the same video fragment 161. If there is no pre-rendered video fragment 161, then the rendering request will be executed in parallel. However, this is not necessary, and only one rendering execution is needed. Therefore, the system may wait for the rendering to complete and use the rendered result right away rather than duplicating tasks.

The blueprint 151 may also be configured to allow for keyframe rendering to provide a preview image. The front-end cannot access the real-time server rendering results. By sending the request of rendering of a single keyframe to the server, the keyframe final output can be displayed. Key frames may be defined in the blueprint 151. Each key frame contains the corresponding editable fields. Once run, a render request can be sent to obtain a preview image of a single keyframe.

The blueprint 151 can also provide adaptive copy solutions. Absent any defined adaptive strategies, the system will default to selecting the output element size and then zooming to the target ruler. It can crop the copy to the same height or width, then trim off any excess. If the original width/original height are greater than the target width/target height, the system will first zoom to the same height as the target height, then cut off the excess width. If the original width/original height are less than the target width/target height, the system will first zoom to the same width as the target height, then trim off any excess height. More control can be achieved when building the volume 157. In addition, the blueprint 151 can be set to use different fusions 155 for different output sizes.

Adopting plug-ins to fusions 155 such as AE, NUKE, Houdini, UE, and using the hook method to modify the generated volume 157 at a specific stage of video production, and then generating the video from the volume 157 allows for self-adapting text typesetting and solving the needs of text animation and typesetting diversity in the video.

Other methods of text inclusion may be used. For example, adaptive text layouts may be achieved by adjusting the internal text box to the appropriate size and position according to the video specifications, adjusting the font size within a certain range, and adjusting the spacing so that the text box boundary does not exceed the text box. Using this method, auto line breaks or maintaining consistency in line count can be achieved.

Text animation may be achieved by splitting the input text into individual text nodes according to line, word, and character. Each text node is followed by transformation attribute nodes such as transform, where the animation parameters are set for those nodes and passed on.

A mixed text layout may be achieved by setting a fixed style to replace the text. The fixed style is composed of several text nodes, text adaptive nodes, etc. The text of these nodes is combined into a typeset designed for the video. The input node of the plug-in is a text node. the fixed style follows the changes in text, font, color, font size, etc. of the input node.

An intelligent layout may also be achieved. The system intelligently adjusts the font size, alignment, color, etc. of the inputted dynamic text based on a set design principle, design guideline, and input parameters, and selectively adds design element borders such as divider lines, etc., without the need for users to design it themselves, creating a visual feel of text layout.

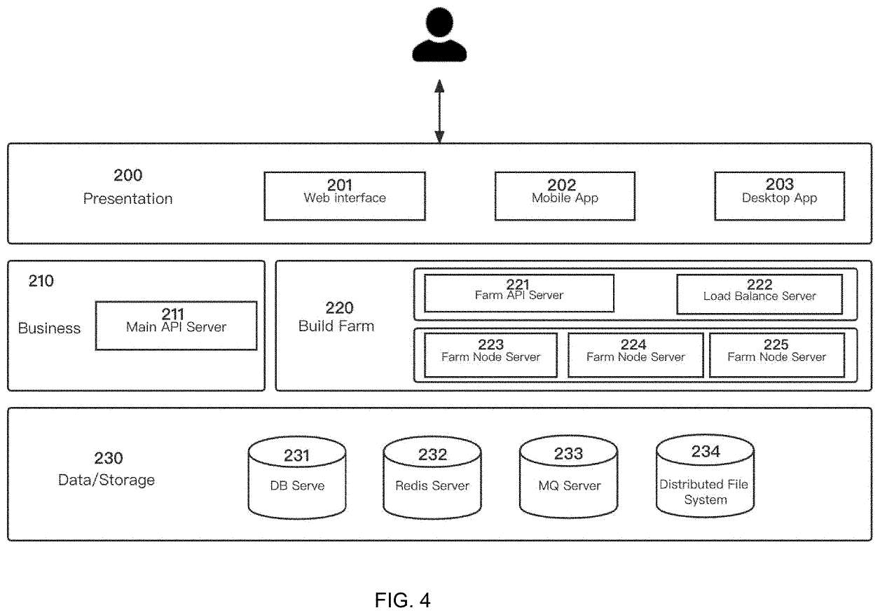

FIG. 4 shows a sample system architecture for a video generation system. The system architecture may include a presentation layer 200, a business layer 210, a build farm 220, and a data/storage layer 230.

The presentation layer 200 may include a web interface 201, a mobile app 202, and/or a desktop app 203. The user interacts with the system through one of the web interface 201, a mobile app 202, and/or a desktop app 203. The user can select their blueprint, create a creative, upload resource files, and views the final video files, etc. After setting the creative-related parameters or input resources, the user can click to preview the storyboard keyframe rendered image output.

The business layer 210 may include a main API server 211. The main API server 211 is responsible for processing user requests, sending video production requests to the build farm 220 directly or through a message queue for processing. Considering performance issues, general video production requests are sent asynchronously to the build farm 220 through a message queue.

The build farm 220 may include a farm API server 221, which is responsible for receiving rendering requests from users. The main API server 211 can send rendering requests to the farm API server 221 in two ways. First, the main API server 211 may put the request into the message queue 233, and the farm API server 221 obtains the request information from the message queue 233. After completing the basic operations, the relevant data is put into the database system such as the Redis server 232 again for the subsequent farm node server cluster 223, 224, 225 to use. Second, the main API server 211 can directly call the interface of the farm API server 221 and request the rendering request to be processed immediately. This is used to render places with high real-time requirements (such as single-frame pictures for preview).

The build farm 220 may include a load balance server 222, which is responsible for viewing the number of rendering requests in the current system, calculating the appropriate number of rendering servers based on the number, and then starting or shutting down the rendering servers. The load balance server 222 may start up more servers to ensure performance when the number of requests is high and shut down redundant rendering servers when the number of requests is low, saving costs. The load balance server mainly operates for the farm node servers 223, 224, 225 type of servers. The load balancing of other types of servers can be achieved through related services provided by various cloud server vendors or open source implementations such as k8s.

The build farm 220 may include farm node servers 223, 224, 225. The number of farm node servers 223, 224, 225 may vary. farm node servers 223, 224, 225 consumes computing resources and processing time, and are responsible for creating and processing various types of chores. There may be many farm node servers 223, 224, 225 in the system, which form a cluster and process video rendering tasks at the same time. The rendering task of a video is divided into many fragments, which are rendered by multiple farm node servers 223, 224, 225 at the same time.

The data/storage layer 230 may include a database server 231 and/or a Redis server 232 to store system data. Two types of database servers are mainly used. The first is a traditional relational database, such as Postgres SQL, Mysql. Second is an in-memory database, such as Redis. Relational databases are mainly used for persistent data storage, while Redis servers 232 are used for caching and temporary data storage, especially temporary data generated during the rendering process. Farm node servers 223, 224, 225 cluster rendering processes a large amount of temporary data which will be read and written at the same time, so that using an in-memory database like Redis has a significant performance advantage over traditional relational databases.

The data/storage layer 230 may include a message queue (MQ) server 233, responsible for asynchronous communication between main API server 211, farm API server 221, and farm node servers 223, 224, 225. Compared with calling APIs between them, the MQ server 233 can avoid excessive load or failure of farm API server 221 or farm node servers 223, 224, 225 because there is a risk that the video request will fail.

The data/storage layer 230 may include a distributed file system 234 to store video resources, temporary files created during the process of creating videos, final video files, etc. There are many different types of servers that must mount the same file system: The main API server 211 is responsible for receiving user-uploaded resource files and forwarding them to this file system. The distributed file system 234 is needed when the final video file is handed over to the client. When the farm API server 221 obtains the progress of the currently generated video, it needs to calculate the rendering progress by checking the log file of the relevant rendering progress in the distributed file system 234. The process of creating the video requires massive throughput in reading and writing to this distributed file system 234 from the farm node servers 223, 224, 225. This distributed file system 234 can be built by itself, or it can rely on file storage services provided by cloud server vendors, such as AWS EFS, etc.

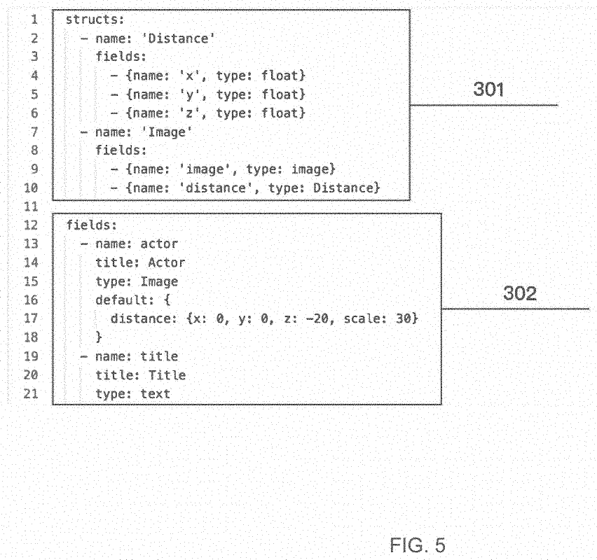

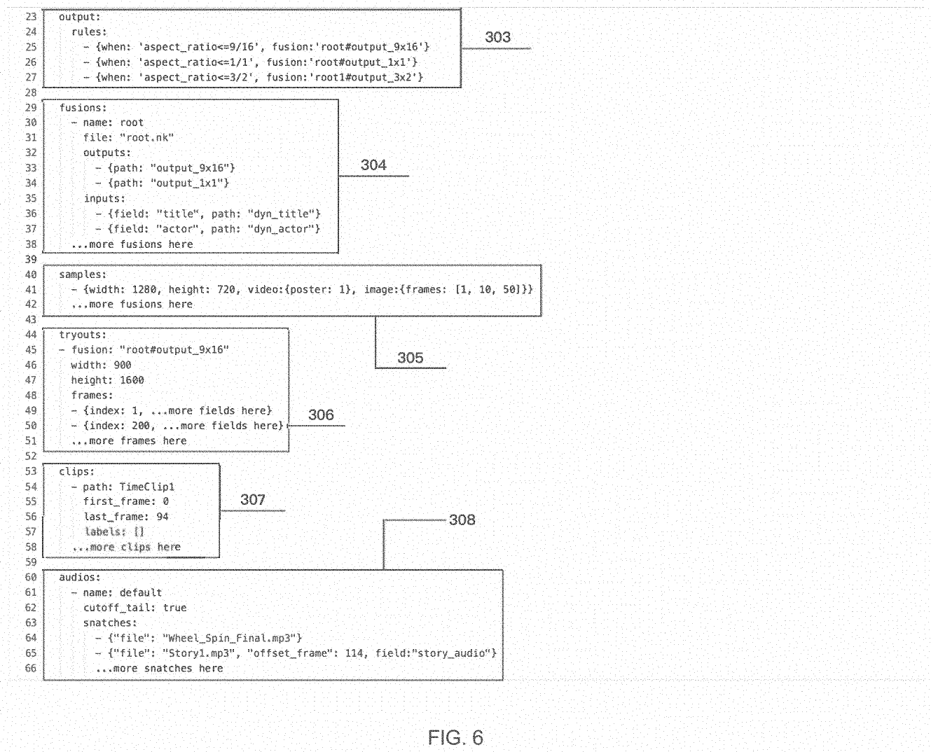

An example blueprint, the initial template used to create the video, is shown in FIGS. 5 and 6. FIGS. 5 and 6 show a “Blueprint.yaml” file, which is a basic blueprint configuration file, which mainly includes custom data types, configurable field definitions, fusions definitions, audio definitions, adaptive definitions, preview key frame definitions, multiple video clip definitions, and more.

Section 301 shows that for blueprints can have customized compound data types Each custom type is composed of some basic types (such as: number, string, text, color) and other combinations. For example, section 301 defines a “Distance” type, which represents a distance in a 3D scene, which includes x, y, z properties. In addition, it also defines an “Image” type displayed in the 3D scene, which contains an original image type and the distance type defined above to express its distance from the camera in the 3D scene.

Section 302 describes the fields that can be modified by the user in this blueprint and their data type default values. The types of these fields can be the custom composite data types defined in 301. For example, this defines an actor field and a title field. The field can contain the frame information of the video that it may affect. This is helpful for caching the rendering results during rendering and improving the rendering speed.

Section 303 shows the output node, which defines the matching rules of the output video and the specific matching conditions. The fusion parameters define which output of which fusion will finally output.

Section 304 shows fusions definitions, which can define multiple Fusion configurations, and the output of fusion defines candidate output node information. The inputs define the fields to map to the specific nodes of the current fusion. The settings of a field can be mapped to various fusions in different nodes.

Section 305 provides the samples section, which is used to output the default template video and picture preview, which is used in the blueprint list, so that the user can select the appropriate blueprint through the picture and preview video.

Section 306 provides the tryouts, which define the key frame information that can be previewed during the creative editing process. It defines the field and field location information that appear in this key frame. After the user edits the corresponding field, the server will be submitted to the server to render the preview image in time.

Section 307 provides the clips section, which defines multiple video clips, and these video clips can be adjusted in order at will. The clip defines the starting frame of each clip, so that the preview key frame corresponding to the tryout is included in the corresponding app/web interface clip.

Section 308, the audio section, defines the relevant information of the audio files used in the final synthesis of the video. An audio can be created by splicing together two audio clips. To define the relative offset value (frame number, time, custom label) of each sound clip in the settings; whether it is clip-related, if so, when adjusting the clip order, the sound clip will also be intelligently calculated where it needs to appear. The input fields related to it can be defined in audio, so that the user can upload an audio file to replace the preset audio.

The system also allows for feed-based mass video generation. Using the front-end interface, one single video can be created by setting parameters to generate a video. To meet large-volume needs, the system may provide a solution for converting data from different data sources into videos. From the point of abstraction, the system can be considered as a tool for realizing the mapping of data to video.

In one example, the system can support data in any format, such as structured data, such as: XML, JSON, etc., and table type data such as Excel, Google table, etc. Structured data is easy to map to the needs of the system (e.g., corresponding to a blueprint).

For table type data, the table itself is only two-dimensional data, and it has no structure. However, express arrays, data structure nesting, etc., may still be expressed.

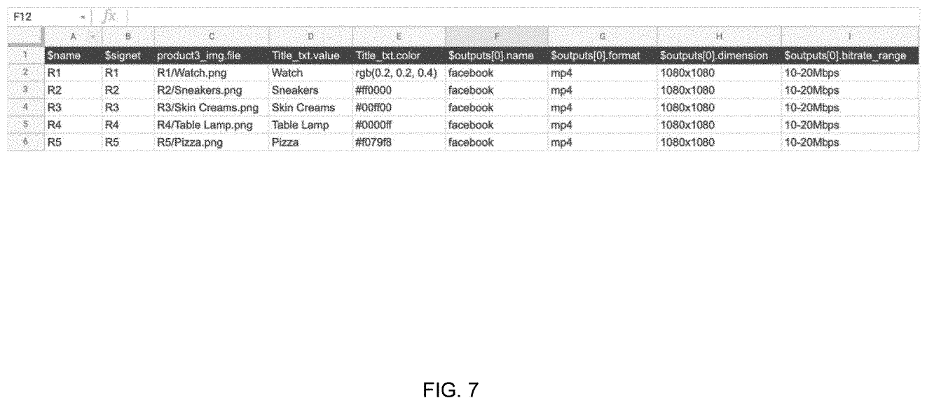

As shown in FIG. 7, the properties used for setting are defined by names beginning with “$”, such as: name, output video size, bit rate, etc.

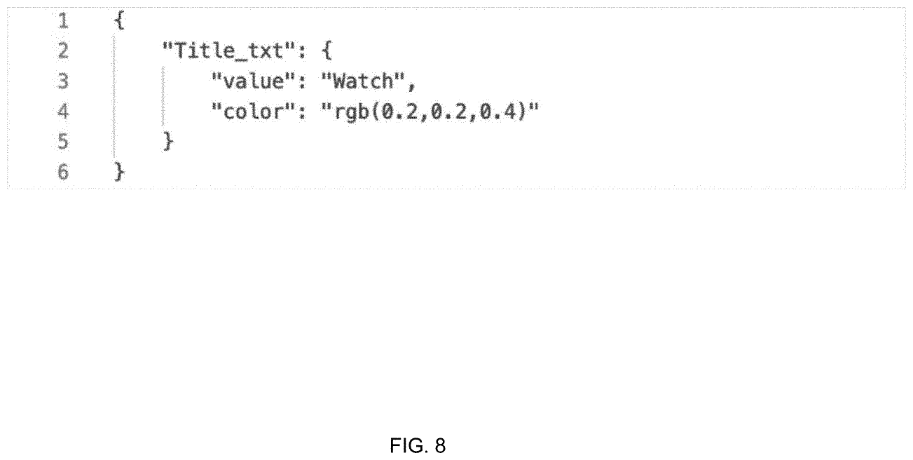

Intervals (“.”) can be used to form object definitions, such as Title_txt, which uses .value and .color. This corresponds to the structured data shown in FIG. 8.

As shown in FIG. 7, “[ ]” can be used to represent array definitions, such as the definition of output video, where “$outputs[0]” represents the definition of the first video output.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

To aid the Patent Office and any readers of any patent issued on this application in interpreting the claims appended hereto, Applicant that it does not intend any of the claims or claim elements to invoke 35 U.S.C. 112(f) unless the words “means for” or “step for” are explicitly used in the particular claim.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A system for video generation, comprising:
a computer;
a database in data communication with said computer, storing a plurality of blueprints;
a user device in data communication with said computer;
the computer receiving at least one asset and a selection of a blueprint from said user device;
the computer rendering at least one video based on the at least one asset and the blueprint associated with said selection;
at least one advertising platform in data communication with said computer;
the advertising platform receiving at least one video and displaying the at least one video;
the advertising platform generating performance data based on the display of the at least one video;
the computer rendering an additional video based on the at least one asset, the blueprint associated with said selection, and the performance data associated with the at least one video.

2. The system of claim 1, further comprising an adjustable setting associated with the selected blueprint.

3. The system of claim 2, wherein the at least one video is a plurality of videos, each of the plurality of videos being different from the others of the plurality of videos based on a change of the adjustable setting when rendered by said computer.

4. The system of claim 3, wherein the performance data is specific to each of the plurality of videos; and
the computer correlating differences in the performance data with the changes in the adjustable setting for each of the plurality of videos.

5. The system of claim 4, wherein rendering an additional video based on the performance data includes using the correlation to optimize the adjustable setting used to render the additional video.

6. The system of claim 5, further comprising multiple adjustable settings the differences for which are correlated with the performance data and used to optimize the adjustable setting used to render the additional video.

7. The system of claim 1, the computer rendering the at least one video is also based on stored performance data associated with the blueprint.

8. The system of claim 1, the computer rendering the at least one video is also based on stored performance data associated with the target demographic.

9. The system of claim 1, further comprising multiple node servers in data communication with said computer for rendering the video.

10. The system of claim 8, wherein the node servers each render portions of a single video.

11. The system of claim 1, wherein the at least one asset is at least one of an image, a video, a 3D object, typeface, copy text, or audio.

12. The system of claim 1, wherein the asset is associated with a brand.

13. The system of claim 1, wherein each of the plurality of blueprints is associated with a target demographic.

14. The system of claim 11, wherein the selection of a blueprint is a selection of a target demographic.

15. The system of claim 1, further comprising an asset database in data communication with said computer for providing an asset to said computer.

16. The system of claim 1, wherein the performance data is at least one of conversion or engagement percentages.

17. The system of claim 1, further comprising:
rendering key frames of the video;
the user device receiving the key frames;
the computer receiving an approval and rendering the video associated with the key frames.

18. The system of claim 1, wherein an indication of a target demographic is provided to the computer and/or the advertising platform.

19. A method of generating a video advertisement, comprising:
displaying a user interface on a user device;
receiving a blueprint selection, resource files, and input parameters;
rendering key frames for the video based on the blueprint selection, resource files, and input parameters;
displaying a key frames as a preview on the user device;
receiving an acceptance of the preview;
rendering the full video associated with the key frames;
serving the video advertisement.

20. A system for video generation, comprising:
a computer;
a database in data communication with said computer, storing a plurality of blueprints, each having at least two adjustable settings;
a user device in data communication with said computer;
the computer receiving at least one asset and a selection of a blueprint from said user device;
the computer rendering a plurality of videos based on the at least one asset and the blueprint associated with said selection, the computer varying the adjustable settings for each of the plurality of videos;
at least one advertising platform in data communication with said computer;
the advertising platform receiving plurality of videos and displaying the at plurality of videos;
the advertising platform generating performance data based on the display of each of the plurality of videos;
the computer correlating differences in the performance data for each of the plurality of the videos with the changes in the adjustable settings for each of the plurality of videos to determine optimal adjustable settings;
the computer rendering an additional video based on the at least one asset, the blueprint associated with said selection, the optimal adjustable settings.
